(19) United States
(12) Patent Application Publication
(10) Pub. No.: US 2018/0233831 A1
(43) Pub. Date: Aug. 16, 2018

(54) DUAL-POLARIZED ANTENNA RADIATING UNIT AND DUAL-POLARIZED ANTENNA ARRAY

(71) Applicant: Rosenberger Technology (Kunshan) Co., Ltd., Kunshan (CN)

(72) Inventor: Yingtao Luo, Kunshan (CN)

(21) Appl. No.: 15/952,557

(22) Filed: Apr. 13, 2018

Related U.S. Application Data
(63) Continuation of application No. PCT/CN2015/092706, filed on Oct. 23, 2015.

(30) Foreign Application Priority Data
Oct. 21, 2015 (CN) 201510685359.1

(51) Int. Cl. H01Q 21/00; H01Q 21/24

(52) U.S. Cl. CPC H01Q 21/0006; H01Q 15/14; H01Q 21/24

(57) ABSTRACT

The present invention discloses a dual-polarized antenna radiating unit and a dual-polarized antenna array. The antenna radiating unit comprises two supporting members that intersect each other, a radiating surface located on one end of the supporting members and comprising four slots, and a feed network; The antenna array comprises at least an antenna radiating unit, and a multi-frequency multi-column antenna array or a single-column antenna array can be implemented. The present invention effectively solves problems of overlarge size and complex feed of existing dual-polarized antennas.

### CROSS REFERENCE TO RELATED APPLICATIONS

This application is a continuation of International Application No. PCT/CN2015/092706, filed on Oct. 23, 2015, which claims priority to Chinese Patent Application No. 201510685359.1, filed on Oct. 21, 2015, the disclosures of which are hereby incorporated by reference.

### FIELD OF THE INVENTION

The present invention relates to the field of communication technologies, and more particularly, to a dual-polarized antenna radiating unit and a dual-polarized antenna array.

### BACKGROUND

With the increasingly updated sciences and technologies, mobile communication has come into people's daily life, and plays an important role. Since the user number is rapidly increased, the working frequency bands of various systemtic mobile communications are continuously expanded, so that the demand on an antenna radiating unit is continuously increased.

In a dual-polarized radiating unit system, people have invested lots of manpowers and material resources to conduct wide and deep research, several dual-polarized antennas have be published, but almost each of those antennas need a lot of spare parts basically. Otherwise, low receptance, low frequency wave band, or other defects may be generated. In the prior art, for example, document CN1418388A discloses a dual-polarized dipole array antenna, wherein a bowl-shape dual-polarized unit is formed by four sets of dipoles, and coaxial line symmetrical feeds are used in the feeds. Specifically, with reference to FIG. 1, the feature of the antenna is that a dipole square (3, 5) rotates by 45 degrees relative to a vertical line or a horizontal line for orientation, feeds (33, 35) related to two orthogonal parallel dipoles (113, 115) of one dipole square (3, 5) is conducted in such a manner that a feed cable (27) is directed to a feed point (33) on a dipole (13″, 15″); starting from the feed point (33), a connection cable (37) is disposed in the feed point (35) on the respectively orthogonal parallel dipole (13′, 15′) of the dipole square (3, 5) and is electrically connected there to the half dipoles (13′, 15′) of the dipole square (3, 5).

Although the existing dual-polarized antenna above can obtain the effects of improving antenna polarization diversity performance and reducing total cable costs, the defects of complex feed and overlarge volume still exist.

### SUMMARY OF THE INVENTION

The object of the present invention lies in overcoming the defect of the prior art, and providing a dual-polarized antenna radiating unit and a dual-polarized antenna array to reduce the size of the antenna and make the feed be simple, which avoids intersected wire jumper.

In order to realize the object above, the present invention provides the following technical solution. A dual-polarized antenna radiating unit comprises two sets of feed slots, and a feed network, wherein each set of feed slots is composed of two opposite slots distributed in the same direction or approximately in the same direction, the feed network comprises a power dividing part fixed on one supporting member at least, the power dividing part comprises a first main feed fixed on the supporting member and two branching feeds branched from the first main feed, and the two branching feeds respectively extend to two opposite slots on the radiating surface for feeding.

The present invention further provides a dual-polarized antenna array, which comprises the dual-polarized antenna radiating unit.

The present invention has the beneficial effect that the present invention effectively solves the problems of overlarge size and complex feed of the existing dual-polarized antenna, implements to reduce the height of the antenna and thin the antenna, has simple feeds, and avoids intersected wire jumper.

### BRIEF DESCRIPTION OF THE DRAWINGS

FIG. 1 is a top structural schematic diagram of a dual-polarized dipole antenna array in the prior art;

FIG. 2 is a stereoscopic structural schematic diagram of a dual-polarized antenna radiating unit (a radiating surface is not shown) according to the embodiment 1 of the present invention;

FIG. 3 is a top structural schematic diagram of the dual-polarized antenna radiating unit according to the embodiment 1 of the present invention;

FIG. 4 is a front structural schematic diagram of the dual-polarized antenna radiating unit according to the embodiment 1 of the present invention;

FIG. 5 is a structural schematic diagram that a terminal of a feed line is coupled with an earth capacitor of a radiating surface;

FIG. 6 is a top structural schematic diagram of a feed network of a dual-polarized antenna radiating unit according to the embodiment 2 of the present invention;

FIG. 7 is a top structural schematic diagram of a dual-polarized antenna radiating unit according to the embodiment 3 of the present invention;

FIG. 8 is a stereoscopic structural schematic diagram of a dual-polarized antenna radiating unit additionally provided with a directing sheet according to the present invention; and

FIG. 9 is a structural schematic diagram of a dual-polarized antenna array according to the present invention.

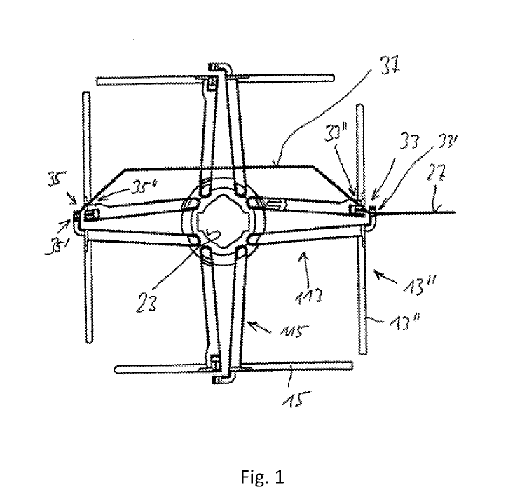

REFERENCE NUMERALS

| | | |
|---|---|---|
| 1 supporting member, | 2 radiating surface, | 3 feed slot, |
| 4 power dividing part, | 41 first main feed, | 42 branching feed, |
| 5 second main feed, | 6 directing sheet. | |

### DETAILED DESCRIPTIONS OF THE PREFERRED EMBODIMENTS

The technical solutions of the embodiments of the present invention will be clearly and completely described hereinafter with reference to the drawings of the present invention.

### Embodiment 1

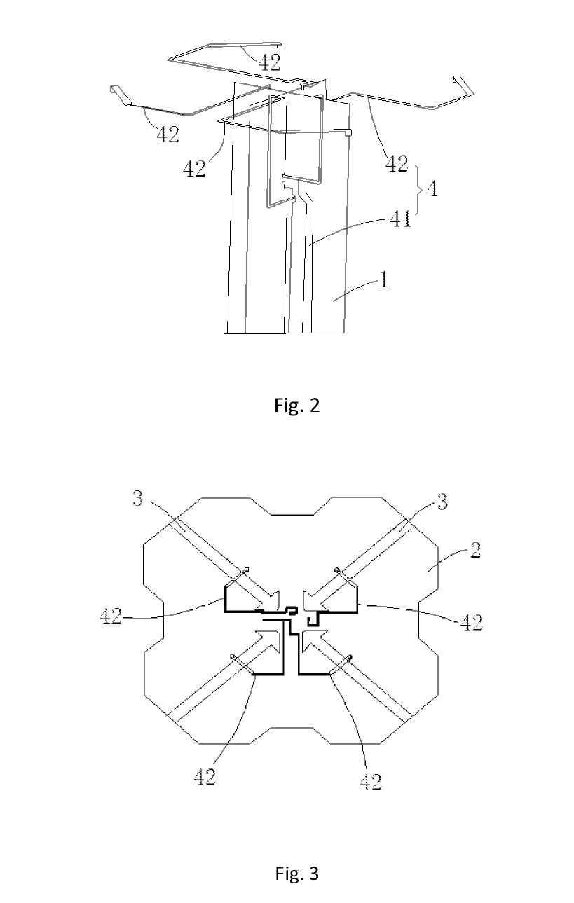

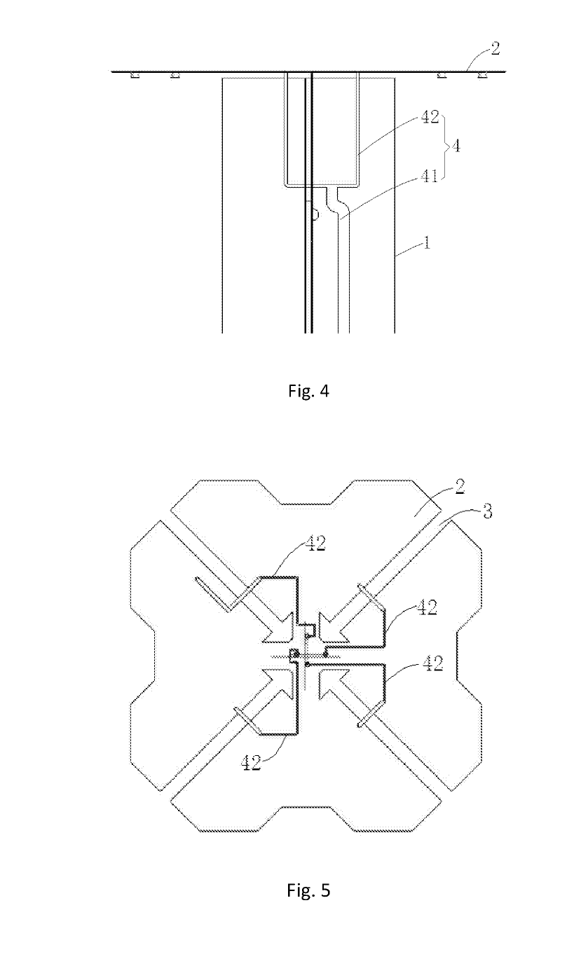

As shown in FIG. 2 to FIG. 4, a dual-polarized antenna radiating unit arranged on a reflecting plate (not shown in the drawings) comprises two supporting members 1, a radiating surface 2 and a feed network, wherein the two supporting members 1 intersect each other, play the role of supporting, and are used in feed distribution. The radiating surface 2 is located on one end of the supporting members 1 and comprises two sets of feed slots 3 on the surface, each set of feed slots 3 is composed of two opposite slots distributed in the same direction or approximately in the same direction, and preferably, two slots in the same direction or approximately in the same direction can have a certain dislocation or a certain angle difference.

The feed network comprises two power dividing parts 4 respectively fixed on two supporting members 1. That is, a supporting member 1 is provided with a power dividing part 4. Each power dividing part 4 comprises a first main feed 41 and two branching feeds 42, the first main feed 41 is fixed on the supporting member 1, and two branching feeds 42 are branched from the first main feed 41. It can be understood that the two branching feeds 42 have two first main feeds 41, four branching feeds 42 are branched from the two first main feeds 41, wherein two branching feeds 42 respectively extend to two opposite slots on the radiating surface 2 for feeding, and another two branching feeds 42 respectively extend to another two opposite slots on the radiating surface 2 for feeding.

In addition, with reference to FIG. 5, a terminal of at least one of the four branching feeds 42 on four slots for feeding is directly connected to the ground of the radiating surface 2, or is directly coupled with an earth capacitor of the radiating surface 2.

### Embodiment 2

A dual-polarized antenna radiating unit arranged on a reflecting plate (not shown in the drawings) comprises two supporting members 1, a radiating surface 2 and a feed network, wherein the two supporting members 1 intersect each other, the radiating surface 2 is located on one end of the supporting members 1 and comprises two sets of feed slots 3 on the surface, each set of feed slots 3 is composed of two opposite slots distributed in the same direction or approximately in the same direction, and preferably, two slots in the same direction or approximately in the same direction can have a certain dislocation or a certain angle difference.

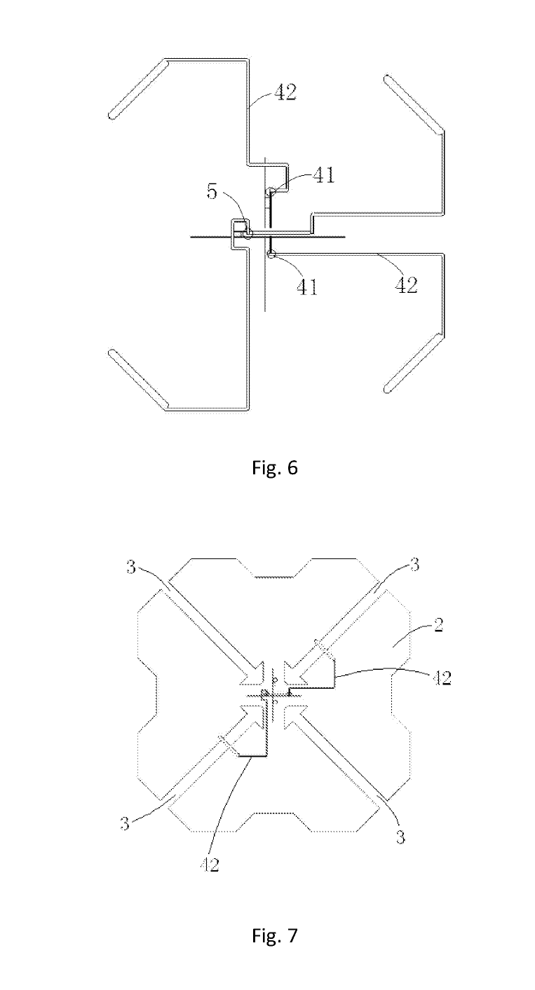

As shown in FIG. 6, the feed network comprises a power dividing part fixed on one of the supporting members and a second main feed 5 fixed on the other supporting members, the power dividing part comprises a first main feed 41 and two branching feeds 42, the first main feed 41 is fixed on the supporting members, the two branching feeds 42 are branched from the first main feed 41 and respectively extend to another two opposite slots on the radiating surface for feeding, and the second main feed 5 directly extend to another two opposite slots on the radiating surface for feeding. That is, the power dividing part is directly implemented on the radiating surface.

In addition, a terminal of at least one of the two branching feeds 42 on four slots for feeding is directly connected to the ground of the radiating surface, or is directly coupled with an earth capacitor of the radiating surface.

### Embodiment 3

A dual-polarized antenna radiating unit arranged on a reflecting plate (not shown in the drawings) comprises two supporting members 1, a radiating surface 2 and a feed network, wherein the two supporting members intersect each other, play the role of supporting, and are used in feed distribution; the radiating surface 2 is located on one end of the supporting members 1 and comprises two sets of feed slots 3 on the surface, each set of feed slots 3 is composed of two opposite slots distributed in the same direction or approximately in the same direction, and preferably, two slots in the same direction or approximately in the same direction can have a certain dislocation or a certain angle difference.

As shown in FIG. 7, the feed network comprises a power dividing part fixed on one of the supporting, the power dividing part comprises a first main feed fixed on the supporting member and two branching feeds 42 branched from the first main feed, and the two branching feeds 42 respectively extend to two opposite slots 3 on the radiating surface 2 for feeding.

In addition, a terminal of at least one of the two branching feeds 42 on the slots for feeding is directly connected to the ground of the radiating surface, or is directly coupled with an earth capacitor of the radiating surface.

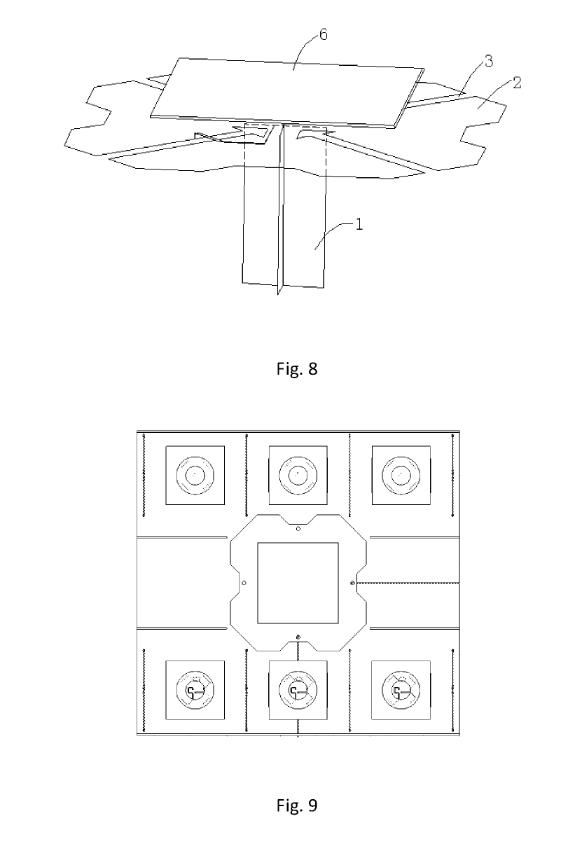

As shown in FIG. 8, based on the structure of the dual-polarized antenna radiating unit in embodiments 1 to 3, a directing sheet 6 is arranged above the radiating surface 2, the arrangement of the directing sheet 6 can enable the antenna radiating unit to be matched well under the condition that the height is lower than the height of the traditional antenna radiating unit on one hand, and can improve the cross polarization of the antenna on the other hand.

Through the test, the preferential frequency band of the dual-polarized antenna radiating unit according to the present invention is: 560 MHZ˜960 MHz and 1690 MHz˜2690 MHz, and the dual-polarized antenna radiating unit can certainly be used to other frequency bands.

The dual-polarized antenna radiating unit according to the present invention is preferentially implemented by a PCB, or by a metal plate and a metal plate with line feed, and the dual-polarized antenna radiating unit can further be implemented by other forms at the same time.

As shown in FIG. 9, the present invention further discloses a dual-polarized antenna array, which comprises at least one of any dual-polarized antenna radiating unit introduced above. The realizable dual-polarized antenna array is at least a multi-frequency multi-column antenna array or a single-column antenna array.

The technical contents and technical features of the present invention have been disclosed above, but those skilled in the art can still make various replacements and modifications without departing from the spirit of the present invention based on the instruction and disclosure of the present invention. Therefore, the protection scope of the present invention shall include various replacements and modifications without departing from the present invention, rather than being limited to the contents disclosed by the embodiments, and shall be covered by the claims of the application of the patent.

1. A dual-polarized antenna radiating unit, comprising two supporting members that intersect each other, a radiating surface located on one end of the supporting members and comprising two sets of feed slots, and a feed network, wherein each set of feed slots is composed of two opposite slots distributed in the same direction or approximately in the same direction, the feed network comprises a power dividing part fixed on one supporting member at least, the power dividing part comprises a first main feed fixed on the supporting member and two branching feeds branched from the first main feed, and the two branching feeds respectively extend to two opposite slots on the radiating surface for feeding.

2. The dual-polarized antenna radiating unit according to claim 1, wherein the feed network comprises the power dividing part respectively fixed on one supporting member, each power dividing part comprises a first main feed fixed on the supporting member respectively and the two branching feeds branched from the first main feed, and the two branching feeds respectively extend to the two opposite slots on the radiating surface for feeding, and in addition, the two branching feeds respectively extend to another two opposite slots on the radiating surface for feeding.

3. The dual-polarized antenna radiating unit according to claim 2, wherein a terminal of the branching feeds is directly connected to the ground of the radiating surface.

4. The dual-polarized antenna radiating unit according to claim 2, wherein a terminal of the branching feeds is coupled with an earth capacitor of the radiating surface.

5. The dual-polarized antenna radiating unit according to claim 1, wherein two opposite slots in the four slots have dislocation or angle difference.

6. The dual-polarized antenna radiating unit according to claim 1, wherein one of the two branching feeds directly extends to one corresponding slot on the radiating surface for feeding, and the other one passes through a hole in the supporting member to extend to the other corresponding slot on the radiating surface for feeding.

7. The dual-polarized antenna radiating unit according to claim 1, wherein a directing sheet is arranged above the radiating surface.

8. A dual-polarized antenna array, comprising at least the dual-polarized antenna radiating unit according to claim 1.

9. The dual-polarized antenna array according to claim 8, wherein the dual-polarized antenna array is at least a multi-frequency multi-column antenna array or a single-column antenna array.

10. The dual-polarized antenna radiating unit according to claim 1, wherein the feed network comprises a power dividing part fixed on one of the supporting members and a second main feed fixed on the other supporting members, the power dividing part comprises the first main feed fixed on the supporting member and the two branching feeds branched from the first main feed, the two branching feeds respectively extend to the two opposite slots on the radiating surface for feeding, and the second main feed directly extends to another two opposite slots on the radiating surface for feeding.

11. The dual-polarized antenna radiating unit according to claim 10, wherein a terminal of the second main feed is directly connected to the ground of the radiating surface.

12. The dual-polarized antenna radiating unit according to claim 10, wherein a terminal of the second main feed is coupled with an earth capacitor of the radiating surface.

13. The dual-polarized antenna radiating unit according to claim 10, wherein a directing sheet is arranged above the radiating surface.
